(19) United States
(12) Patent Application Publication
(10) Pub. No.: US 2010/0075532 A1
(43) Pub. Date: Mar. 25, 2010

(54) Fluorescent Marker for Detecting Gel or Lack of Gel

(75) Inventors: Warren Copp-Howland, Chicopee, MA (US); Sriram Govindarajulu, Sprinfield, MA (US); John Riordan, Ludlow, MA (US)

Correspondence Address: TYCO HEALTHCARE GROUP LP, 15 HAMPSHIRE STREET, MANSFIELD, MA, 02048, US

(73) Assignee: Tyco Healthcare Group LP, Mansfield, MA (US)

(21) Appl. No.: 12/237,831

(22) Filed: Sep. 25, 2008

(51) Int. Cl. H01R 3/00; H01B 1/12; G01J 1/58

(52) U.S. Cl. 439/488; 252/501.1; 250/459.1

(57) ABSTRACT

A conductive composition having a transparent and colorless appearance under normal or ambient lighting and at least a dyed, translucent or fluorescent appearance under artificial lighting is provided. The composition includes a photo-reactive quantity of a dye-marker.

### BACKGROUND

1. Technical Field

The present application relates to transparent and colorless conductive compositions and hydrogels and, more particularly, to photo-luminescent or photo-reactive hydrogels that have a transparent and colorless appearance under normal or ambient lighting and a dyed translucent, or fluorescent appearance under artificial lighting and methods of using or manufacturing objects such as biomedical electrodes including the same.

2. Background of Related Art

Hydrogels are used in many applications, including and not limited to applications in the medical field. One exemplary use of hydrogels in the medical field includes the use thereof in electrodes. Electrodes (e.g., diagnostic, therapeutic and/or monitoring type) are used to transmit electrical signals or currents between the body of a patient and external or remote equipment (e.g., diagnostic, therapeutic/stimulating and/or monitoring devices). Such electrodes typically include a conductive hydrogel adherable to or otherwise contactable with, the skin of the patient, and a conductor, which is electrically connected to the conductive hydrogel and to the external equipment. In many instances, hydrogels are transparent and colorless in order for the underlying surface on which the hydrogel is placed to be visible to the naked eye or imaging equipment (e.g., camera). During a manufacturing process it is desirable for the hydrogel to be visible by the naked eye and/or imaging equipment in order to detect a number of properties of the hydrogel itself, such as the presence or absence of hydrogel.

Accordingly, a need exists for a conductive composition that is transparent and colorless under normal or ordinary lighting during use, and which is visible under artificial lighting (e.g., UV, black or blue light) during production, manufacture and/or incorporation into an end product.

### SUMMARY

The present application relates to photo-luminescent or photo-reactive conductive compositions that have a transparent or colorless appearance under normal or ambient lighting and a dyed, translucent, or fluorescent appearance under artificial lighting and methods of using or manufacturing objects including the same.

According to an aspect of the present disclosure, a conductive composition having a transparent or colorless appearance under normal or ambient lighting and at least a dyed, translucent, or fluorescent appearance under artificial lighting is provided. The conductive composition includes a photo-reactive quantity of a dye-marker. The conductive composition has a transparent and colorless appearance under normal or ambient lighting and at least a dyed, translucent, or fluorescent appearance under artificial lighting.

The composition may be a hydrogel. The hydrogel may be conductive and/or selectively adherable.

The dye-marker may be a fluorochrome. The fluorochrome may be fluorescein sodium. The fluorescein sodium may have a concentration of about 1-100%. The composition may include about 1-1000 ppm of flourescein sodium.

According to another aspect of the present disclosure, an electrode for attachment to the skin of a subject is provided. The electrode includes a conductive member; a conductive composition disposed on a first side of the conductive member, wherein the conductive composition includes a photo-reactive quantity of a dye-marker; and an electrical lead in electrical communication with the conductive member. The conductive composition has a transparent and colorless appearance under normal or ambient lighting and at least a dyed or translucent or fluorescent appearance under artificial lighting.

The composition may be a hydrogel. The hydrogel may be conductive and/or selectively adherable to the skin of a subject.

The dye-marker may be a fluorochrome. The fluorochrome may be fluorescein sodium. The fluorescein sodium may have a concentration of about 1-100%. The conductive composition may include about 1-1000 ppm of flourescein sodium.

The electrode may include a backing member disposed on a second side of the conductive member.

The electrode may include a release liner, removably adhered to a surface of the conductive composition.

The electrode may include a reinforcement member supporting the conductive composition.

The electrode may include a layer of silver (Ag) or silver/silver-chloride (Ag/AgCl) disposed on at least a portion of at least one of the first and second sides of the conductive member.

The electrical lead may be a pig-tail style leadwire, snap style, tab style, riveted-post style.

According to yet another aspect of the present disclosure, a method of manufacturing and/or inspecting an object including a quantity of a transparent and colorless conductive composition when viewed under normal or ambient lighting conditions is provided. The method includes the steps of providing an object including a conductive composition having a photo-reactive quantity of a dye-marker; wherein the conductive composition has a transparent and colorless appearance under normal or ambient lighting and at least a dyed, translucent, or fluorescent appearance under artificial lighting; and illuminating, stimulating or exciting the object with an artificial light source to cause the photo-reactive quantity of the dye-marker to irradiate, whereby the composition becomes dyed, translucent, or fluorescent.

The method may further include the step of observing at least the conductive composition to determine at least one of a quantity and a quality of the conductive composition present in the object.

The method may further include the step of providing the conductive composition with a fluorochrome dye-marker. The method may further include the step of providing the composition with a fluorochrome of fluorescein sodium. The method may further include the step of providing the composition with a dye-marker of fluorescein sodium having a concentration of about 1-100%. The method may further include the step of providing the composition with a dye-marker including about 1-1000 ppm of flourescein sodium. Alternatively, the fluorochrome may be rhodamine.

The conductive composition may be a hydrogel.

The method may further include the step of exciting, illuminating, or stimulating the object with an artificial light source having a wavelength of about 420 nm to about 480 nm. The method may further include the step of exciting, illuminating, or stimulating the object with at least one of a UV, a blue and a black artificial light source.

The method may further include the step of placing the object in a darkened environment prior to the step of illuminating or stimulating the object with the artificial light source.

### DETAILED DESCRIPTION OF THE DRAWINGS

The accompanying drawings, which are incorporated in and constitute a part of this specification, illustrate embodiments of the disclosure and, together with a general description of the disclosure given above, and the detailed description of the embodiment(s) given below, serve to explain the principles of the disclosure, wherein:

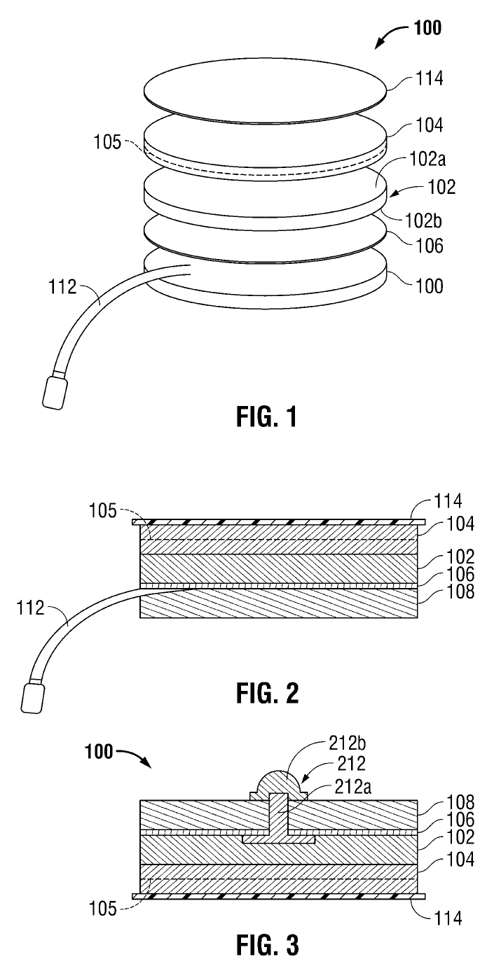

FIG. 1 is a schematic, perspective view of an exemplary leadwire electrode of the present disclosure, shown with layers separated;

FIG. 2 is a cross-sectional view, of the electrode of FIG. 1;

FIG. 3 is a cross-sectional view, of a snap style electrode, according to an embodiment of the present disclosure;

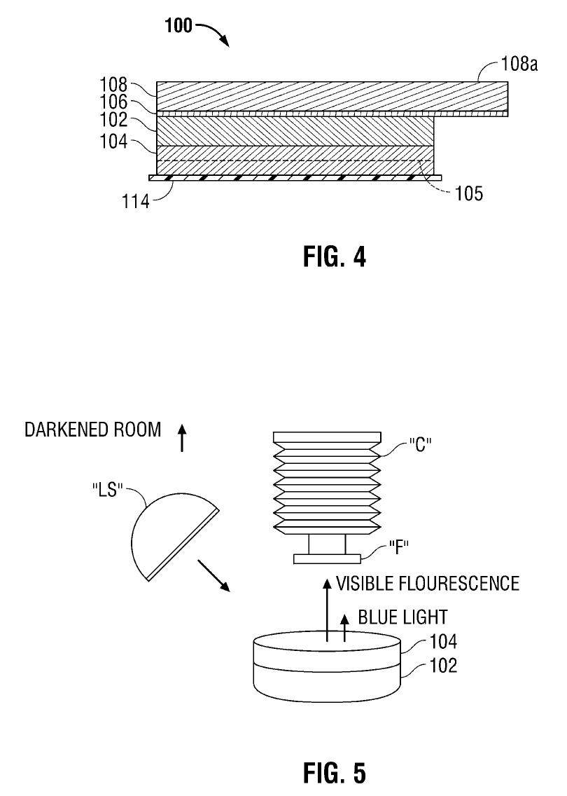

FIG. 4 is a cross-sectional view, of a tab style electrode, according to an embodiment of the present disclosure; and

FIG. 5 is a schematic illustration of a method of manufacture according to the present disclosure.

### DETAILED DESCRIPTION OF EMBODIMENTS

Embodiments of the present disclosure will now be described in detail with reference to the drawing figures wherein like reference numerals identify similar or identical elements.

Referring initially to FIGS. 1 and 2, an electrode in accordance with an embodiment of the present disclosure is generally designated as electrode 100. Electrode 100 includes a conductive member 102 defining a first or skin side 102a relative to a subject and a second side 102b, opposite first side 102a. Conductive member 102 may be made from a conductive carbon, aluminum, tin or any other suitable conductive material. As an alternative, conductive member 102 may comprise a conductive plastic material. Conductive member 102 may include silver (Ag) or silver/silver-chloride (Ag/AgCl) material deposited on at least a portion of first side 102a or second side 102b. Either first side 102a or second side 102b may also have a coating of silver (Ag) or silver/silver-chloride (Ag/AgCl) composition or ink 106 on either first side 102a or second side 102b thereof.

Electrode 100 further includes a conductive composition 104 disposed adjacent first side 102a of the conductive member 102 for application/adhesion to or contact with the skin of the subject. Conductive composition 104 may be made from, for example, but not limited to, Promeon RG-63B hydrogel (TycoHealthcare Group LP d/b/a Covidien). As seen in FIGS. 1 and 2, in some embodiments, conductive composition 104 may incorporate a reinforcement member. The reinforcement member may be a woven or non-woven cloth or gauze material (e.g., scrim) 105 embedded therewithin or supporting the structure of the hydrogel. The reinforcement member may be made from a conductive material. The conductive composition 104 may be any different commercially available conductive hydrogel. Conductive composition 104 is generally hydrophilic.

Conductive composition 104 has a photo-reactive quantity of a dye-marker or fluorochrome incorporated therein. In accordance with the present disclosure, the dye-marker of fluorochrome may be a photo-luminescent material. For example, conductive composition 104 may include fluorescein sodium or rhodamine incorporated therein. In this manner, conductive composition 104 is transparent and colorless under normal or ambient lighting conditions and dyed, translucent, or fluorescent under artificial lighting conditions.

While fluorochromes fluoresce under stimulation by ultraviolet radiation, some, particularly those derived from fluorescein or fluorescein sodium, fluoresce at a higher degree under ultraviolet (UV), blue or black-light stimulation. In accordance with the present disclosure, it is contemplated that the photo-reactive quantity of the dye-marker IFWB-CO commercially available from Risk Reactor, Huntington, Calif.

The fluorochrome is added to conductive composition 104 in an amount sufficient to irradiate or photo-luminesce under artificial lighting (e.g., excitation under UV, blue or black-light) to thereby make conductive composition 104 appear dyed or translucent. The fluorochrome may have a concentration of about 1-100%. Conductive composition 104 may include about 1-1000 ppm of fluorochrome.

By providing conductive composition 104 with a photo-reactive quantity of a dye-marker, during the manufacture of electrode 100, during or following application of conductive composition 104, electrode 100 may be irradiated or excited with an artificial light source (e.g., a UV, black or blue light, etc.) in order to determine if an adequate quantity of conductive composition 104 has been applied or dispensed to conductive member 102, to determine if any conductive composition 104 has been applied outside of a target area (e.g., not entirely on conductive member 102), and to determine whether inconsistencies of coverage of conductive composition 104 on conductive member 102 exist that would lead to product quality issues.

Therefore, electrode 100 may be viewed under artificial lighting (e.g., UV, blue or black light), and viewed by the human eye or by a camera to determine whether or not a desired quantity and/or quality of conductive composition 104 has been applied to conductive member 102. Due to the reversible nature of the photo-luminescence the addition of fluorochrome is especially useful for hydrogel coatings or materials that are intended to be transparent or colorless under normal or ambient lighting conditions, where coverage can be difficult to determine by conventional means. Further, the reversible nature is non-detectable by the end user.

A first side release liner 114 is releasably secured to conductive composition 104. Release liner 114 can be made from a film or paper substrate having a release coating on one or both sides, such as, for example silicone. Release liner 114 protects and/or preserves conductive composition 104 (e.g., the hydrogel) and is removed prior to application on the skin of the subject. Release liner 114 may be applied to conductive composition 104 after use of electrode 100 to preserve the conductive composition 104 for subsequent use.

Release liner 114 may be a release paper or film of a waxed or coated plastic, such as a silicone coated polyethylene terephthalate film, which may be used to protect electrode 100 before application of the electrode to the skin of the subject.

In an embodiment, electrode 100 may further include a backing member 108 disposed adjacent second side 102b of conductive member 102. In certain embodiments, backing member 108 may overlie silver coating 106. Backing member 108 is fabricated from a non-conductive material such as a cloth, fabric, plastic material or the like.

Electrode 100 further includes an electrical lead, in the form of a lead wire 112 (as shown in FIGS. 1 and 2). Lead wire 112 has a pig tail configuration that is in electrical communication with at least conductive member 102 and a power supply (not shown). An electrical pathway from external equipment to subject skin extends from lead wire 112 through the conductive member 102, and silver coating 106, and through conductive composition 104 to the subject.

In use, release liner 114 is removed from electrode 100. Electrode 100 is then applied to the skin of the subject, such that conductive composition 104 is adhered to the skin of the subject. Electrode 100 is then electrically connected to external medical equipment (not shown) by any connection means well known in the art, such as, for example, via lead wire 112. Electrode 100 may, by way of example, a TENS electrode to be connected to an electrical stimulation device by means known to one having skill in the art.

Turning now to FIG. 3, electrode 100 may be configured as a snap-style electrode including an electrical lead, in the form of an electrical snap connector 212. Snap connector 212 includes a post 212a in contact with conductive member 102 and extending through silver coating 106 and backing member 108. Snap connector 212 includes a head 212b connected to post 212a.

Referring now to FIG. 4, electrode 100 may be configured as a tab-style electrode wherein backing member 108 includes a portion 108a extending beyond a perimeter or edge of conductive member 102 thereby defining a tab. As seen in FIG. 4, silver coating 106 extends onto the surface of tab portion 108a of backing member 108.

According to the present disclosure, as seen in FIG. 5, during the manufacturing process of electrode 100, while in a darkened environment or room, conductive member 102, including conductive composition 104 is irradiated, stimulated, or excited with an artificial light from a light source “LS” (e.g., UV light, blue or black light, or light in the region of about 420 to about 480 nm). In so doing, conductive composition 104, due to the photo-reactive quantity of dye-marker, will illuminate or radiate with a yellow/green fluorescence at about 530 to 540 nm. This fluorescence or illumination may then be viewed, through an orange barrier or filter “F”, by the naked eye, recorded onto color film or viewed through a color camera “C”.

While the present disclosure has been described in relation to electrodes including a layer of a hydrogel, it is contemplated and within the scope of the present disclosure, that any compound or composition (e.g., gel, film, adhesive, polymer, etc.) requiring or necessitating a clear or transparent appearance under normal lighting conditions and a colored or dyed appearance under artificial lighting is encompassed by the present disclosure.

It will be appreciated that various embodiments of the above-disclosure and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, or material.

What is claimed is:

1. A conductive composition having a transparent or colorless appearance under normal or ambient lighting and at least a dyed, translucent, or fluorescent appearance under artificial lighting, the conductive composition comprising:
a photo-reactive quantity of a dye-marker, wherein the conductive composition has a transparent and colorless appearance under normal or ambient lighting and at least a dyed, translucent, or fluorescent appearance under artificial lighting.

2. The conductive composition according to claim 1, wherein the dye-marker is a fluorochrome.

3. The conductive composition according to claim 2, wherein the fluorochrome is one of fluorescein sodium and rhodamine.

4. The conductive composition according to claim 3, wherein the fluorescein sodium has a concentration of about 1-100%.

5. The conductive composition according to claim 3, wherein the conductive composition includes 1-1000 ppm of flourescein sodium.

6. The conductive composition according to claim 1, wherein the conductive composition is a hydrogel.

7. The conductive composition according to claim 6, wherein the hydrogel is selectively adherable.

8. An electrode for selective attachment to the skin of a subject, the electrode comprising:
a conductive member;
a conductive composition disposed on a first side of the conductive member, wherein the conductive composition includes a photo-reactive quantity of a dye-marker; and
an electrical lead in electrical communication with the conductive member, wherein the conductive composition has a transparent and colorless appearance under normal or ambient lighting and at least a dyed, translucent or fluorescent appearance under artificial lighting.

9. The electrode according to claim 8, wherein the dye-marker is one of a fluorochrome and rhodamine.

10. The electrode according to claim 9, wherein the fluorochrome is fluorescein sodium.

11. The electrode according to claim 10, wherein the fluorescein sodium has a concentration of 1-100%.

12. The electrode according to claim 10, wherein the composition includes about 1-1000 ppm of flourescein sodium.

13. The electrode according to claim 8, wherein the conductive composition is a hydrogel.

14. The electrode according to claim 8, wherein the conductive composition is selectively adherable to the skin of a subject.

15. The electrode according to claim 8, further comprising a backing member disposed on a second side of the conductive member.

16. The electrode according to claim 8, further comprising a release liner selectively, removably adhered to a surface of the conductive composition.

17. The electrode according to claim 8, further comprising a reinforcement member supporting the conductive composition.

18. The electrode according to claim 8, further comprising at least one of silver and silver-chloride on at least a portion of at least one of the first and second sides of the conductive member.

19. The electrode according to claim 8, wherein the electrical lead is one of a pig-tail style electrical leadwire, a snap style electrical lead and a tab style electrical lead.

20. A method of manufacturing and/or inspecting an object including a quantity of a transparent and colorless conductive composition when viewed under normal or ambient lighting conditions, the method comprising the steps of:
providing an object including a conductive composition having a photo-reactive quantity of a dye-marker; wherein the conductive composition has a transparent and colorless appearance under normal or ambient lighting and at least a dyed, translucent, or fluorescent appearance under artificial lighting; and
exciting the object with an artificial light source to cause the photo-reactive quantity of the dye-marker to irradiate, whereby the conductive composition becomes at least one of colored, translucent and fluorescent.

21. The method according to claim 20, further comprising the step of observing at least the conductive composition to determine at least one of a quantity and a quality of the conductive composition present in the object.

22. The method according to claim 20, further comprising the step of providing the conductive composition with a fluorochrome dye-marker.

23. The method according to claim 20, further comprising the step of providing the conductive composition with a dye-marker of one of fluorescein sodium and rhodamine.

24. The method according to claim 20, further comprising the step of providing the composition with a dye-marker of fluorescein sodium having a concentration of 1-100%.

25. The method according to claim 20, further comprising the step of providing the composition with a dye-marker including about 1-1000 ppm of flourescein sodium.

26. The method according to claim 20, wherein the composition is a hydrogel.

27. The method according to claim 20, further comprising the step of exciting the object with an artificial light source having a wavelength of about 420 nm to about 480 nm.

28. The method according to claim 20, further comprising the step of exciting the object with a UV light source.

29. The method according to claim 20, further comprising the step of placing the object in a darkened environment prior to the step of exciting the object with the artificial light source.
